(19) United States
(12) Patent Application Publication
(10) Pub. No.: US 2002/0088156 A1
(43) Pub. Date: Jul. 11, 2002

(54) Article of manufacture for reflecting the holidays

(76) Inventors: Russell Milligan, Orange, TX (US); Meritta D. Taylor, Orange, TX (US)

Correspondence Address: BlueSpider Innovations, 811 Dayton St., Orange, TX, 77630, US

(21) Appl. No.: 09/756,585

(22) Filed: Jan. 8, 2001

(51) Int. Cl. G09F 7/12

(52) U.S. Cl. 40/594

(57) ABSTRACT

An article of manufacture for reflecting the holidays with, Reflections, which will be made from a durable, self-adhesive film, clip on or taping. The tape or stripping will clip on, stick, or be self-adhesive, and The reflections will come in a variety of colors, patterns and designs. Reflections will save on possible injuries from using ladders, and light bulbs or electrical wiring which could cause electrical shock. With Reflections there will no longer be hassles from burned out light bulbs, or shorts in the wiring, plus you will save on your electric bill!

### BACKGROUND OF THE INVENTION

This invention relates generally to the field of Reflecting Art, and more particularly to an article of manufacture for reflecting the holidays.

There is no history involved with this product since it will be the only one like it on the market, however, the idea of the invention was derived from the reflectors you see on commercial trucks, and markers found in ditches, etc. . . . The prior technology would be the present way of decorating for the holidays, with wires, light bulbs, etc. . . . The problems identified with the present way of decorating for the holidays is simply this; To light up your house you must have wires with light bulbs, which may or may not work, and finding that one particular light bulb to fix is always a challenge. Included with this is extension cords, or extra electrical outlets, ladders, and best of all no more worrying about the specific layout of your design, because there are no more wires attached. Example: With wires you must make sure the plug ends will match up, and the measurement is exact for the design you want. This procedure could be long and aggravating!, however, with Reflections, the procedure is shorter, simpler, and saver. Just put it in place, without much thought, turn on the flood light, and presto, reflections to remember.

### SUMMARY OF THE INVENTION

The primary object of the invention is To provide a better way to decorate for the holidays.

Another object of the invention is To provide an energy efficient way to decorate for the holidays.

Another object of the invention is To provide a cost effective way to decorate for the holidays.

A further object of the invention is To provide a saver way to decorate in order to prevent injuries.

Yet another object of the invention is To provide an environmentally safe product to decorate for the holidays.

Still yet another object of the invention is To provide a product that requires less storage space than previous products.

Other objects and advantages of the present invention will become apparent from the following descriptions, taken in connection with the accompanying drawings, wherein, by way of illustration and example, an embodiment of the present invention is disclosed.

An article of manufacture for reflecting the holidays. comprising: Reflections will be made from a durable, self-adhesive film, clip on or taping., The tape or stripping will clip on, stick, or be self-adhesive, and The reflections will come in a variety of colors, patterns and designs.

The drawings constitute a part of this specification and include exemplary embodiments to the invention, which may be embodied in various forms. It is to be understood that in some instances various aspects of the invention may be shown exaggerated or enlarged to facilitate an understanding of the invention.

### BRIEF DESCRIPITION OF DRAWINGS

FIG. 1 A perspective view of the invention which would be something like the sample's seen on page 1 of the drawings.

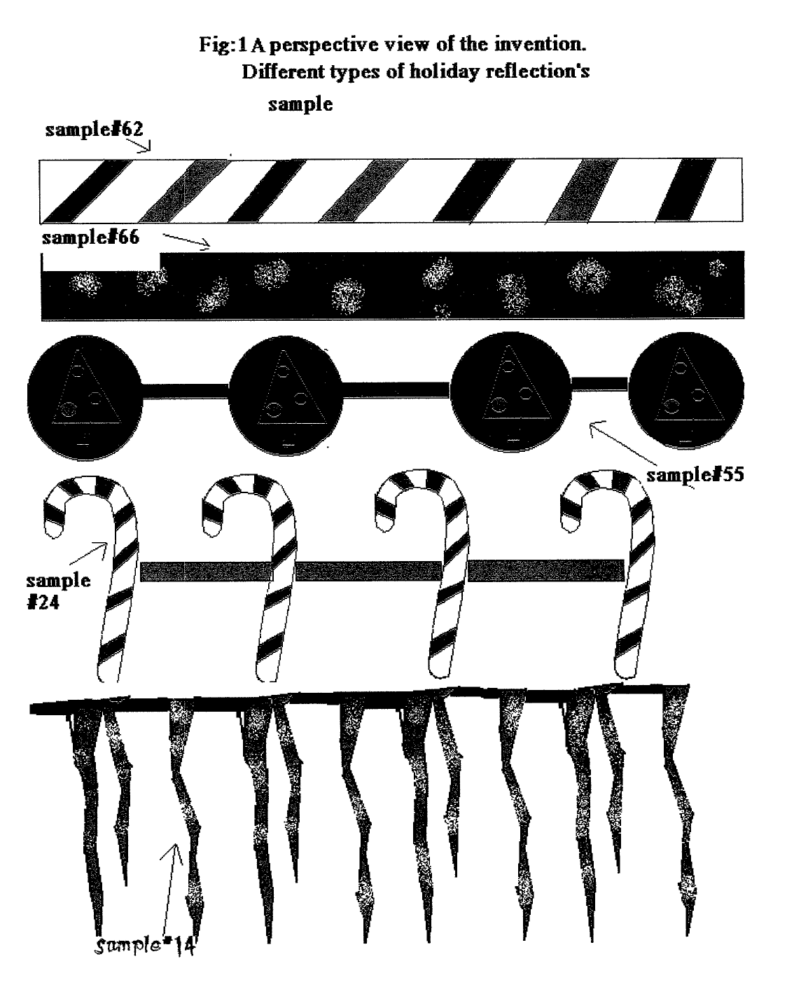

FIG. 2 Is a plan view of the invention applied to the house with samples of page one FIG. 1 samples with one halogen bulb placed in the front yard to reflect the declarations.

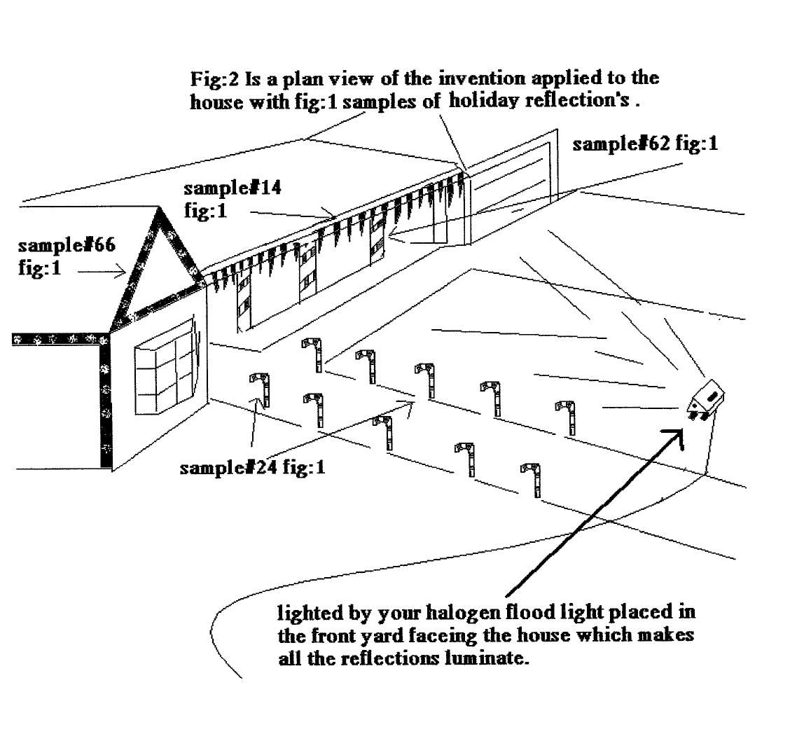

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

Reflections, a new way to decorate for the holidays or any special occasion, such as a birthday, anniversary, graduation, or birth of a child.

Reflections are a saver, energy efficient, cost effective, and fun way to decorate for the holidays. Reflections are made from a durable reflecting tape, reflecting plastic, or reflecting film, which is easily applied with self-adhesive stripping, clip-on, or suction cups if used on windows or glass. If the film is used, it is just simply applied to your bushes, etc. . . . Reflections are a saver way to decorate, because there are no longer strings of wires and bulbs, and numerous extension cords. Reflections are also an energy efficient and cost effective way to decorate. As shown on page one of the drawings, sample # 62, 66, 24, and 14, these examples are more specific to Christmas, however, Reflections will come in a variety of designs and colors.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An article of manufacture for reflecting the holidays. comprising:
Reflections will be made from a durable, self-adhesive film, clip on or taping.;
The tape or stripping will clip on, stick, or be self-adhesive; and
The reflections will come in a variety of colors, patterns and designs.
